(19) United States
(12) Patent Application Publication
(10) Pub. No.: US 2014/0184191 A1
(43) Pub. Date: Jul. 3, 2014

(54) SYSTEM AND DEVICE FOR REDUCING STANDBY POWER CONSUMPTION

(71) Applicants: GUAN-XIONG HUANG, Shenzhen (CN); CALVIN SHIE-NING WANG, Cayman Islands (GB); ZHEN-QIU HUANG, Cayman Islands (GB)

(72) Inventors: GUAN-XIONG HUANG, Shenzhen (CN); CALVIN SHIE-NING WANG, Cayman Islands (GB); ZHEN-QIU HUANG, Cayman Islands (GB)

(21) Appl. No.: 14/140,551

(22) Filed: Dec. 26, 2013

(30) Foreign Application Priority Data
Dec. 26, 2012 (CN) 2012207278584

(51) Int. Cl. H02M 5/293

(52) U.S. Cl. CPC H02M 5/293
USPC 323/351

(57) ABSTRACT

The invention provides a system and a device for reducing standby power consumption. The system for reducing standby power consumption, comprises a power regulator, a power detecting circuit and a HIC module, and the HIC module is controlled by a MCU to efficiently reduce standby power consumption.

### FIELD OF THE INVENTION

The present invention relates generally to a system and a device for reducing standby power consumption. More specifically, the present invention relates to a system and device that utilize a MCU (micro controller unit) to design a structure and a control process for reducing standby power consumption.

### BACKGROUND OF THE INVENTION

With the development of economy in recent years, the electronic appliances are indispensable to people's life. Currently, most of the electronic appliances were designed as infrared control technology integrated, wherein the electronic appliances are controlled by an infrared controller.

However, the problem of high standby power consumption still exists in most electronic appliances. For example, the range of standby power consumption is generally between 1˜3 Watts for most electronic appliances such as television, air-conditioner, electric fan, and other office electronics, etc, which is a waste of energy.

### BRIEF SUMMARY OF THE INVENTION

The invention provides an innovative system and a device for reducing standby power consumption.

In one embodiment of the present invention, a system for reducing standby power consumption, comprises a power regulator connecting to an AC power source; a power detecting circuit connecting to the power regulator and to a load, wherein the power detecting circuit is used to detect a power of the load; and a HIC module, wherein the HIC module determines a mode of the load according to an output power of the power detecting circuit, the output power corresponding to the power of the load, and wherein the HIC module outputs an “off” control signal to the power regulator to switch the power regulator into a “off” state if the HIC module finds that the power of the load is in a predetermined range. In addition, a device for reducing standby power consumption is disclosed as well.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a block diagram of a system for reducing standby power consumption in accordance with one embodiment of the present invention;

FIG. 2 is a schematic diagram of a system for reducing standby power consumption in accordance with one embodiment of the present invention;

FIG. 3 is a block diagram of a HIC module of FIG. 1 in accordance with one embodiment of the present invention.

In accordance with common practice, the various described features are not drawn to scale and are drawn to emphasize features relevant to the present disclosure. Like reference characters denote like elements throughout the figures and text.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

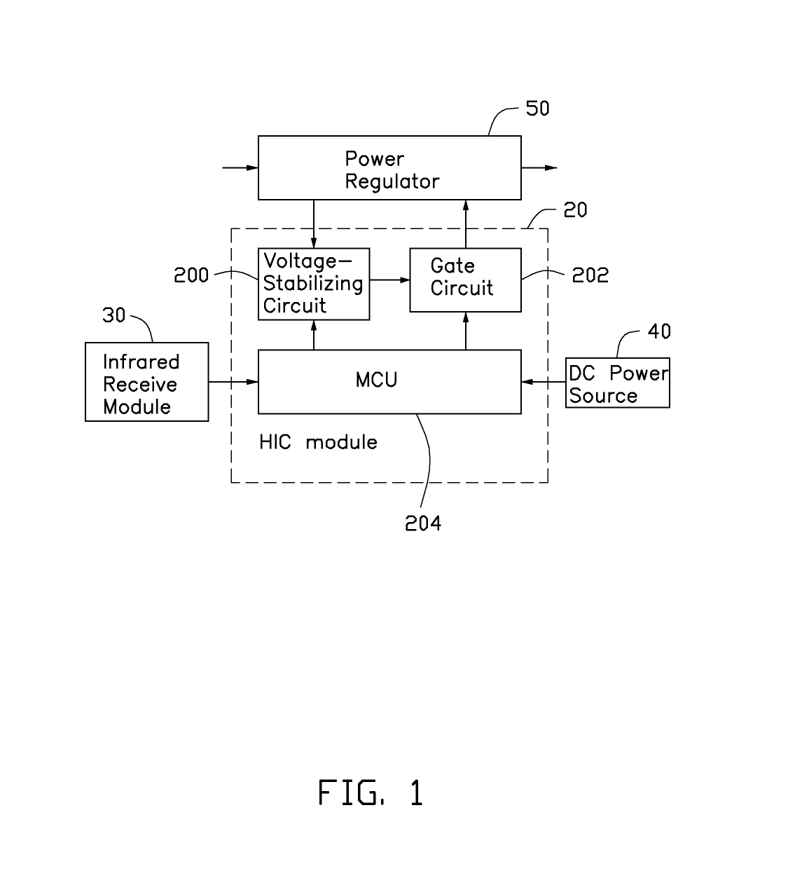

The description will be made as to the embodiments of the present invention in conjunction with the accompanying drawings in FIGS. 1˜3. Reference will be made to the drawing figures to describe the present invention in detail, wherein depicted elements are not necessarily shown to scale and wherein like or similar elements are designated by same or similar reference numeral through the several views and same or similar terminology.

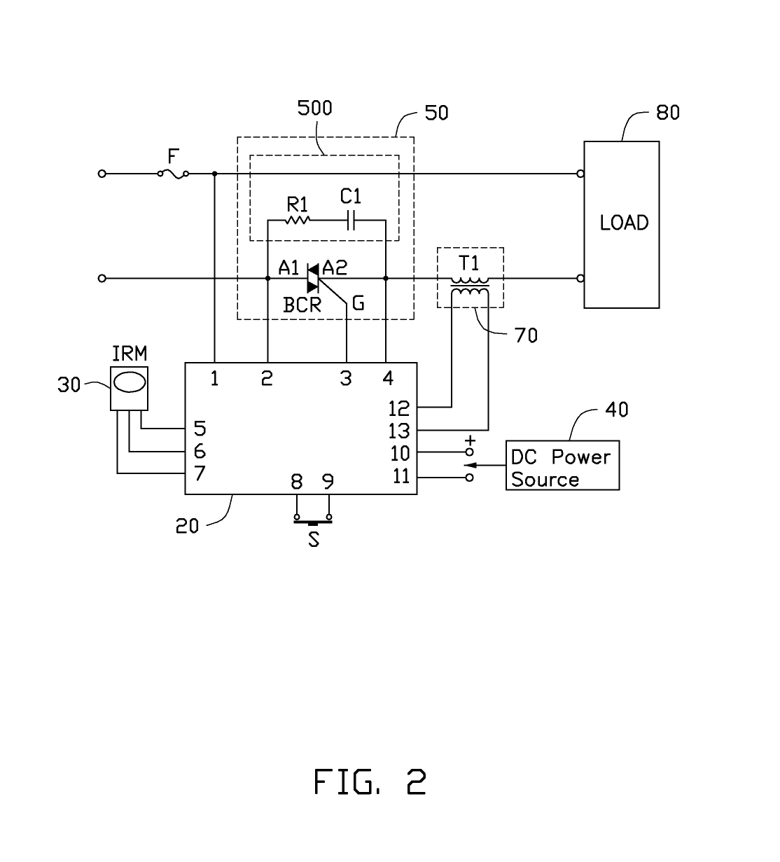

FIG. 1 and FIG. 2 illustrate a system for reducing standby power in accordance with one embodiment of the present invention, the system including a HIC (Thick Film Hybrid Integrated Circuit) module 20, a power detecting circuit 70 and a power regulator 50.

The power regulator 50 is connected to an AC power source. The power detecting circuit 70 is connected to the power regulator 50 and to a load 80. In one embodiment of the present invention, the power regulator 50 may be in an “on” or “off” state for disconnecting or connecting the AC power source to the load 80.

The power detecting circuit 70 is designed for detecting the power of the load 80 and outputting a power corresponding to the power of the load 80 to the HIC module 20.

The HIC module 20 includes a first pin (pin 1), a second pin (pin 2), a third pin (pin 3), a fourth pin (pin 4),a fifth pin (pin 5), a sixth pin (pin 6), a seventh pin (pin 7), a eighth pin (pin 8), a ninth pin (pin 9), a tenth pin (pin 10), a eleventh pin (pin 11), a twelfth pin (pin 12), and a thirteenth pin (pin 13).

Referring to FIG. 2, the power detecting circuit 70 may include a current transformer T1. A primary coil of the current transformer T1 is connected to the load 80 and a secondary coil of the current transformer T1 is connected to the pin 12 and pin 13. Therefore, when the current transformer T1 is connected to a wire for transmitting AC signal, the secondary coil of the current transformer T1 may generate a output current through pin 12 and pin 13 of the HIC module 20 (the twelfth pin and the thirteenth pin of the HIC module 20) to the HIC module 20. The HIC module 20 determines a mode of the load 80 (i.e. a standby mode and an operating mode) according to the output power of the power detecting circuit 70.

Specifically, the HIC module 20 receives the output current of the secondary coil of the current transformer T1 and the AC power source provides the voltage, so the HIC module 20 is able to calculate the power of the load 80 to determine the mode of load 80. If the power of the load 80 is within a predetermined range (i.e. 1˜3W), the HIC module 20 determines that the load 80 is in the standby mode. If the power of the load 80 is larger than the upper bound (i.e. 3W) of the predetermined range, the HIC module 20 determines that the load 80 is in the operating mode.

In addition, the HIC module 20 controls a mode of the power regulator 50 (i.e. an “on” state and an “off” state) based on the mode of the load 80 (i.e. the standby mode and the operating mode). For example, the HIC module 20 controls the power regulator 50 into an “off” state when the load is in the standby mode, thus avoiding power transmitting from the AC power source to the load 80, reducing power consumption.

Specifically, if the power of the load 80 is within the predetermined range (the standby power consumption of the load 80 is less than the normal power consumption of the load 80), the HIC module 20 outputs an “off” control signal to the power regulator 50 to control the power regulator 50 into the “off” state, so that the original standby power consumption of the load 80 decreases from 1˜3W to less than 0.1W, thus reducing power consumption.

It should be noticed that the HIC module 20, the power detecting circuit 70, the load 80 and the power regulator 50 may be installed in an appliance, such as TV or other appliances.

In FIGS. 1 and 2, the system for reducing standby power consumption may include an IRM 30 (Infrared Receive Module). Pin 5 to pin 7 of the HIC module 20 (The fifth pin to the seventh pin of the HIC module 20) is connected to the IRM 30. The HIC module 20 may receive at least one command of the mode of the load 80 from a user, such as a “turn on” command or a “turn off” command.

Also, the HIC module 20 may receive the at least one command from the user via other types of communication interface, such as the communication interface of Wi-Fi or Zigbee.

Specifically, after receiving the “turn off” command from the user, the HIC module 20 determines whether the load 80 is in the “off” state according to the output power of the power detecting circuit 70. Namely, the power detecting circuit 70 determines whether the power of the load 80 is in the predetermined range, such as 1˜3W.

If the power of the load 80 is larger than the upper bound of the predetermined range, the HIC module 20 delays the first predetermined time before the HIC module 20 outputs the “off” control signal to the power regulator 50 to control power regulator 50 into the “off” state, so that the load 80 switches to the standby mode within the first predetermined time.

After receiving the “turn on” command from the user, the HIC module 20 outputs an “on” control signal to the power regulator 50 in the “on” state, so that the load 80 is connected to the AC power source and thus switches to the operating mode.

In addition, after receiving the “turn on” command, the HIC module 20 delays a second predetermined time to obtain the power of the load 80 detected by the power detecting circuit 70 and thus determines whether the power of the load 80 is larger than the upper bound of the predetermined range.

If the power of the load 80 is larger than the upper bound of the predetermined range, the load 80 is in a normal state of the operating mode. If the power of the load 80 is within the predetermined range, the load 80 is in an abnormal state of the operating mode. If the load 80 is in the abnormal state of the operating mode, the HIC module 20 outputs a warning signal according to the abnormal state.

Specifically, in FIG. 2, the power regulator 50 includes a BCR (Bi-directional Silicon Controlled Rectifier) and a RC (Resistor-capacitor) circuit 500. A first anode A1 of the BCR and a second anode A2 of the BCR is connected to the wire connecting the AC power source. A control gate G of the BCR is connected to pin 3 of the HIC module 20 (the third pin of the HIC module 20) to control a “on” state or an “off” state. If the BCR receives the “off” control signal from the HIC module 20, the BCR is switched to the “off” state. If the BCR receives the “on” control signal from the HIC module 20, the BCR is switched to the “on” state, so that the AC power source is able to provide power to the load 80.

Referring to FIG. 2, the RC circuit 500 is used to filter a signal by blocking certain frequencies and passing others. The RC circuit 500 includes a resistor R1 and a capacitor C1. The resistor R1 is in series with the capacitor C1, and the RC circuit 500 is in parallel with the first anode A1 of the BCR and the second anode of the BCR. The resistor R1 is connected to pin 2 of the HIC module 20 (the second pin of the HIC module 20) and the capacitor C1 is connected to pin 4 of the HIC module 20 (the fourth pin of the HIC module 20). However, it should be noticed that the RC circuit 500 may not be included in the power regulator 50.

Pin 8 and pin 9 of the HIC module 20 (the eighth pin and the ninth pin of the HIC module 20) is connected to a switch S, and the switch S is used to reset the HIC module 20. Pin 10 and pin 11 of the HIC module 20 (the tenth pin and the eleventh pin of the HIC module 20) is used to be connected to a DC (directly current) power source 40. For example: a battery power source, a capacitor power source or a DC power source from the feedback of the load 80.

In addition, the system for reducing standby power consumption may also comprise a protecting device F. The protecting device F may be installed and connected to the AC power source so as to protect the load 80. The protecting device F may be a Fuse.

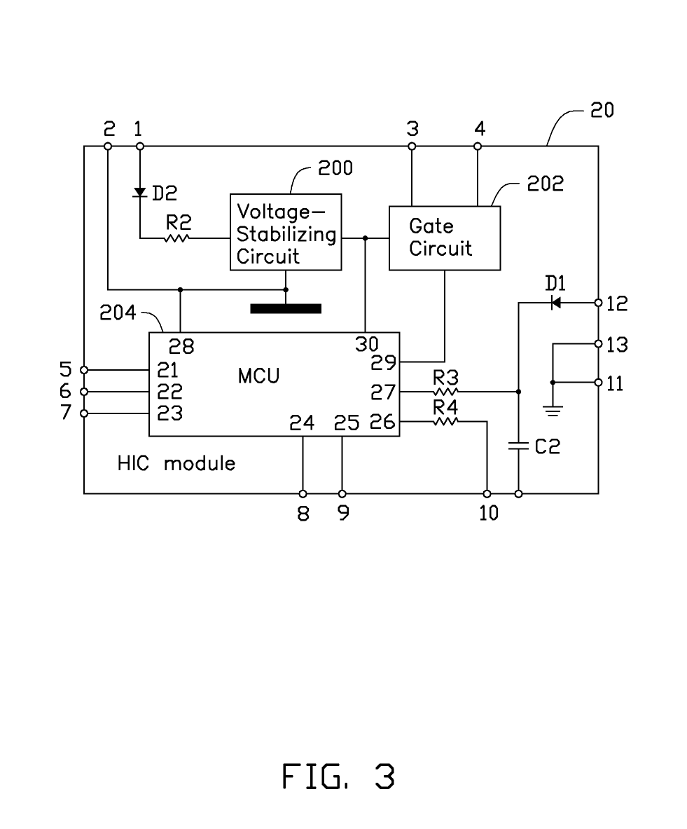

Referring to FIG. 3, the HIC module 20 comprises a MCU 204 (Micro Controller Unit), a voltage-stabilizing circuit 200 and a gate circuit 202.

The MCU 204 is the core of the HIC module 20. Through the build-in programmable execution of the MCU 204, such as calculation, comparison and analysis, the MCU 204 is able to control the switch action of every component in the HIC module 20, thus reducing power standby consumption. The MCU 204 includes a first pin to a tenth pin (pin 21 to a pin 31).

Each of pin 21, pin 22 and pin 23 of the MCU 204 is respectively connected to pin 5, pin 6 and pin 7 of the HIC module 20 so as to receive a signal corresponding to an infrared light which the IRM 30 receives.

Each of pin 24 and pin 25 of the MCU 204 is respectively connected to pin 8 and pin 9 of the HIC module 20 so as to reset the MCU 204 through the switch S.

Pin 26 of the MCU 204 (the sixth pin of the MCU 204) is connected to pin 10 of the HIC module 20 via the Resistor R4 and the pin 11 of the HIC module 20 is connected to ground, thereby forming a close loop, so that the DC power source 40 can supply power to the MCU 204.

Pin 27 of the MCU 204 (the seventh pin of the MCU 204) is connected to the pin 12 of the HIC module 20 via a diode Dl and a Resistor R3 and the pin 13 of the HIC module is connected to ground, thereby forming a close loop, so that the MCU 204 is able to receive the output current from the current transformer T1 through pin 12 and pin 13 of the HIC module 20.

Pin 28 of the MCU 204 (the eighth pin of the MCU 204) is connected to the pin 2 of the HIC module 20 and is also connected to ground. Moreover, the wire for transmitting AC signal is connected to pin 1 of the HIC module 20 (the first pin of the HIC module 20), and the anode of a diode D2 is connected to pin 1 of the HIC module 20. The cathode of the diode D2 a resistor R2 is connected to the voltage-stabilizing circuit 200 via a resistor R2.

Pin 29 of the MCU 204 (the ninth pin of the MCU 204) is connected to the gate circuit 202 to provide a control signal to the gate circuit 202. The gate circuit 202 is kind of switch control component used to trigger the mode of the power regulator 50, such as the “on” or “off” state. In addition, the MCU 204 is connected to ground via a resistor R3 and a capacitor C2.

Specifically, the MCU 204 is able to be in a sleep mode or a wake-up mode, so that the HIC module 20 works according to the sleep mode or the wake-up mode of the MCU 204.

For example, after receiving the “turn off” command from the user, the MCU 204 controls the BCR to be in the “off” state and the MCU 204 switches to the sleep mode, so the HIC module 20 also enters into the sleep mode). As a result, the MCU 204 reduces its power consumption and thus reduces standby power consumption.

After receiving the “turn on” command, the MCU 204 switches to the wake-up mode from the sleep mode and thus the HIC module 20 enters into the wake-up mode, thus switching the BCR to the “on” state. Hence, the load 80 is connected to the AC power source and returns back to the operating mode.

Specifically, after receiving the “turn on” command via pin 21 to pin 23, the MCU 204 switches from the sleep mode to the wake-up mode. So, when MCU switches to the wake-up mode, the voltage-stabilizing circuit 200 obtains an AC current via pin 1 and pin 2 of the HIC module 20, thus providing a start-up current to the MCU 204 via pin 30 of the MCU 204 (the tenth pin of the MCU 204) and also providing the start-up current to the gate circuit 202.

The start-up current is able to continue for milliseconds, such as 1 to at least 10 milliseconds. The MCU 204 provides the control signal to the gate circuit 202 via pin 29 and thus switches the power regulator 50 to the “on” state. Once the power regulator 50 switch to the “on” state, the load 80 is able to obtain the power from the AC power source to start operation in the operating mode. Then, the load 80 provides the DC power source 40 as a feedback to the HIC module 20, thus maintaining normal operation of the system for reducing standby power consumption. After the HIC module 20 obtain the power from the DC power source, the voltage-stabilizing circuit 200 enters into a sleep mode.

Through a number of experiments and test experiences, the original standby power consumption of appliances is 1˜3W. After the HIC module 20 is used to control the power regulator 50, the standby power consumption changes to 0.04˜0.08W, meaning that standby power consumption is reduced and the power is efficiently saved.

In view of the above, the system and device for reducing standby power consumption have the HIC module 20 and the power regulator 50 inside and is able to be installed into the appliances.

Previous descriptions are only embodiments of the present invention and are not intended to limit the scope of the present invention. Many variations and modifications according to the claims and specification of the disclosure are still within the scope of the claimed invention. In addition, each of the embodiments and claims does not have to achieve all the advantages or characteristics disclosed. Moreover, the abstract and the title only serve to facilitate searching patent documents and are not intended in any way to limit the scope of the claimed invention.

What is claimed is:

1. A system for reducing standby power consumption, comprising:
a power regulator connecting to an AC power source;
a power detecting circuit connecting to the power regulator and to a load, wherein the power detecting circuit is used to detect a power of the load; and
a HIC module, wherein the HIC module determines a mode of the load according to an output power of the power detecting circuit, the output power corresponding to the power of the load, and wherein the HIC module outputs an “off” control signal to the power regulator to switch the power regulator into a “off” state if the HIC module finds that the power of the load is in a predetermined range.

2. The system of claim 1, wherein the power detecting circuit comprises a current transformer, wherein the current transformer has a primary coil connected to the load and a secondary coil of the current transformer connected to the HIC module, such that the current transformer generates an output current corresponding to the power of the load and the HIC module calculates the power of the load according to output current of the current transformer.

3. The system of claim 1, further comprising:
a communication interface, wherein the telecommunication interface is connected to the HIC module and the HIC module receives at least one command via the communication interface; wherein the HIC module determines the mode of the load according to the output power of the power detecting circuit if the HIC module receives a first command, such that (1) if the load is in a operating mode, the HIC module delays a first predetermined time to output an “off” control signal to the power regulator and the HIC module enters into a sleep mode, (2) if the load is in the standby mode, the HIC module outputs the “off” control signal to power regulator and the HIC module enters into the sleep mode; and wherein the HIC module switches to a wake-up mode the from sleep mode if the HIC module receives a second command, such that the HIC module outputs an “on” control signal to the power regulator, thus making the power regulator in an “on” state.

4. The system of claim 3, wherein the HIC module delays a second predetermined time to determine whether the power of the load is larger than an upper bound of the predetermined range when outputting the “on” control signal to power regulator, such that if the power of the load is less than the upper bound of the predetermined range, the HIC outputs a warning signal.

5. The system of claim 3, wherein the communication interface is an infrared receive module.

6. The system of claim 1, wherein the HIC module comprises:
a MCU;
a voltage-stabilizing circuit; and
a gate circuit, wherein the MCU outputs a corresponding control signal to the gate circuit according to a command received by the MCU, such that (1) when receiving the control signal corresponding to a first command, the gate circuit outputs the “off” control signal to the power regulator, and (2) when receiving the control signal corresponding to a second command, the gate circuit outputs an “on” control signal to the power regulator.

7. The system of claim 6, wherein the voltage regulator provides a start-up current to the MCU after the MCU receives the second command.

8. The system of claim 7, wherein, after receiving the start-up current, the MCU controls the gate circuit to output the “on” control signal to the power regulator, thereby switching the load to an operating mode, such that the load provides a DC power source to the HIC module after the load is switched to the operating mode.

9. The system of claim 1, wherein the power regulator comprises a bi-directional silicon controlled rectifier (BCR), and a first anode of the BCR and a second anode of the BCR are connected to the AC power source and the control gate of the BCR is connected to the HIC module, and wherein the BCR is switched to an “off” state after receiving the “off” control signal from the HIC module, or the BCR is switched to an “on” state after receiving the “on” control signal from the HIC module.

10. The system of claim 9, wherein the power regulator further comprises a RC circuit having a first resistor and a first capacitor in series with the first resistor, and the RC circuit is in parallel with the first anode and the second anode of the BCR.

11. A device for reducing standby power consumption, comprising:
a load;
a power regulator connecting to an AC power source;
a power detecting circuit connecting to the power regulator and to the load, wherein the power detecting circuit is used to detect a power of the load; and
a HIC module, wherein the HIC module determines a mode of the load according to an output power of the power detecting circuit, the output power corresponding to the power of the load, and wherein the HIC module outputs an “off” control signal to the power regulator to switch the power regulator into an “off” state if the HIC module finds that the power of the load is in a predetermined range.

12. The device of claim 11, wherein the power detecting circuit comprises a current transformer, wherein the current transformer has a primary coil connected to the load and a secondary coil of the current transformer connected to the HIC module, such that the current transformer generates an output current corresponding to the power of the load and the HIC module calculates the power of the load according to output current of the current transformer.

13. The device of claim 11, further comprising:
a communication interface, wherein the telecommunication interface is connected to the HIC module and the HIC module receives at least one command via the communication interface; wherein the HIC module determines the mode of the load according to the output power of the power detecting circuit if the HIC module receives a first command, such that (1) if the load is in a operating mode, the HIC module delays a first predetermined time to output an “off” control signal to the power regulator and the HIC module enters into a sleep mode, (2) if the load is in the standby mode, the HIC module outputs the “off” control signal to power regulator and the HIC module enters into the sleep mode; and wherein the HIC module switches to a wake-up mode the from sleep mode if the HIC module receives a second command, such that the HIC module outputs an “on” control signal to the power regulator, thus making the power regulator in an “on” state.

14. The device of claim 13, wherein the HIC module delays a second predetermined time to determine whether the power of the load is larger than an upper bound of the predetermined range when outputting the “on” control signal to power regulator, such that if the power of the load is less than the upper bound of the predetermined range, the HIC outputs a warning signal.

15. The device of claim 3, wherein the communication interface is an infrared receive module.

16. The device of claim 11, wherein the HIC module comprises:
a MCU;
a voltage-stabilizing circuit; and
a gate circuit, wherein the MCU outputs a corresponding control signal to the gate circuit according to a command received by the MCU, such that (1) when receiving the control signal corresponding to a first command, the gate circuit outputs the “off” control signal to the power regulator, and (2) when receiving the control signal corresponding to a second command, the gate circuit outputs an “on” control signal to the power regulator.

17. The device of claim 16, wherein the voltage regulator provides a start-up current to the MCU after the MCU receives the second command.

18. The device of claim 17, wherein, after receiving the start-up current, the MCU controls the gate circuit to output the “on” control signal to the power regulator, thereby switching the load to an operating mode, such that the load provides a DC power source to the HIC module after the load is switched to the operating mode.

19. The device of claim 11, wherein the power regulator comprises a bi-directional silicon controlled rectifier (BCR), and a first anode of the BCR and a second anode of the BCR are connected to the AC power source and the control gate of the BCR is connected to the HIC module, and wherein the BCR is switched to an “off” state after receiving the “off” control signal from the HIC module, or the BCR is switched to an “on” state after receiving the “on” control signal from the HIC module.

20. The device of claim 9, wherein the power regulator further comprises a RC circuit having a first resistor and a first capacitor in series with the first resistor, and the RC circuit is in parallel with the first anode and the second anode of the BCR.
